(19) United States
(12) Patent Application Publication
(10) Pub. No.: US 2008/0270945 A1
(43) Pub. Date: Oct. 30, 2008

(54) Interior spaces in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/789,741

(22) Filed: Apr. 24, 2007

(51) Int. Cl. G06F 3/048

(52) U.S. Cl. 715/848

(57) ABSTRACT

A method, apparatus, and system of interior spaces in a geo-spatial environment are disclosed. In one embodiment, the method includes providing a plurality of user profiles, each user profile in the plurality of user profiles including an associated specific geographic location, selecting a user profile in the plurality of user profiles, generating a first virtual interior space view of a first structure associated with a first specific geographic location of the selected user profile in the plurality of user profiles, and generating, with the first virtual interior space view, at least one wiki profile associated with the first virtual interior space view. The method may also include generating, with the at least one wiki profile, content appended to the at least one wiki profile. Furthermore, the method may include capturing a second virtual interior space view of a second structure associated with a second specific geographic location.

### FIELD OF TECHNOLOGY

This disclosure relates generally to the technical fields of communications and, in one example embodiment, to a method, apparatus, and system of interior spaces in a geo-spatial environment.

### BACKGROUND

Different websites may enable persons to see details of physical entities (e.g., structures) like shopping malls, office complexes, landmarks, houses on sale, etc. However, these virtual views may be limited to exterior features. For example, a potential buyer may not be able to get a virtual interior view of a house that is for sale. Similarly, shoppers may like to view interior spaces of a mall and/or view goods on display before deciding to visit such complexes.

Virtual websites, apart from offering exterior views of buildings, may not provide additional details, for example, profiles of residents, organizations, occupants, etc. in corresponding interior spaces, resulting in suboptimal levels of foot traffic and/or visibility for little known but interesting locations and other places of public and/or individual interest.

Exterior views of a structure (e.g., a physical entity, a building, a mall, a complex, etc.) may not provide an accurate reflection of what may be a better and/or more interesting interior. One may not be satisfied with an outside view and be disinclined to visit the structure, which may be disadvantageous to users, occupants, businesses and/or activities of the structure.

### SUMMARY

A method, apparatus and system of interior spaces in a geo-spatial environment are disclosed. In one aspect, a method includes providing a plurality of user profiles, each user profile in the plurality of user profiles including an associated specific geographic location, selecting a user profile in the plurality of user profiles, generating a first virtual interior space view of a first structure associated with a first specific geographic location of the selected user profile in the plurality of user profiles, and generating, with the first virtual interior space view, at least one wiki profile associated with the first virtual interior space view.

The method may also include generating, with the at least one wiki profile, content appended to the at least one wiki profile. The method may further include capturing a second virtual interior space view of a second structure associated with a second specific geographic location, and associating the second virtual interior space view with the user profile associated with the second specific geographic location in the plurality of profiles. The method may include generating content associated with the at least one wiki profile and appending the content to the associated at least one wiki profile.

In another aspect, a system includes an integrated virtual view environment, a social network module of the integrated virtual view environment to include user profiles, each user profile to include at least one virtual interior space view of a structure (e.g., the structure may further include a geographic area accessible to at least one public person) and a specific geographic location of the structure, a map module to include map data of specific geographic locations, the map data to serve as a basis to correlate the specific geographic locations of the map data with virtual interior space views of structures associated with the specific geographic locations, a selection module to select a user profile in the user profiles, a virtual interior space module to generate the virtual interior space view of the structure of the user profile, and a wiki module to generate, with the virtual interior space view of the structure of the user profile, at least one wiki profile associated with the virtual interior space view of the user profile.

The system may include a content module to generate, with the at least one wiki profile, content appended to the at least one wiki profile. The system may also include a virtual interior space view creation module to capture the virtual interior space view of the structure and to associate the virtual interior space view with a particular user profile in the user profiles. The system may include a locator module to determine a specific geographic location of the structure associated with the virtual interior space view and to associate the specific geographic location of the structure with the captured virtual interior space view.

The system may yet include a wiki profile creation module to create a wiki profile and append the wiki profile to the virtual interior space view of an associated user profile of the user profiles. The system may further include a content creation module to create and append content to the at least one wiki profile associated with the virtual interior space view.

The system may also include a claim module to claim a specific user profile in the user profiles. The system may further include a permission module to permit or prohibit modification of a claimed user profile in the user profiles. Moreover, the system may include a one-click module to select a service associated with a user profile in the user profiles and to provide the selected service based on the specific geographic location of the user profile.

In addition, the system may include a capture device to capture a virtual interior space view of a second structure having a corresponding specific geographic location. The capture device may further include a locator device to determine the specific geographic location of the structure and to associate the corresponding specific geographic location of the structure with the captured virtual interior space view.

In yet another aspect, an integrated virtual view environment includes a first instruction set to enable a social network including a user database, the user database including associated user profiles, the social network to reside above global map data, in which the social network is associated with specific geographic locations identifiable in the global map data, a second instruction set integrated with the first instruction set to select a user profile in the user profiles, the user profile including a layout reference to a layout associated with the specific geographic location identifiable in the global map data, and a third instruction set integrated with the first instruction set and the second instruction set to generate a virtual private property space view (e.g., a zoo map, a walking path in an amusement park, a location visited often by a public audience on a private property, a stadium, a meeting place, a shopping center, a building, and/or an interior space) of a private property associated with the layout reference of the selected user profile.

The integrated virtual view environment may also include a fourth instruction set to generate wiki profiles that may be associated with a specific user profile in the user profiles of the social network. The system may further include a fifth instruction set to generate content (e.g., the content may be appended to the wiki profile).

In addition, the integrated virtual view environment may include a sixth instruction set to capture a virtual interior space view and to associate the virtual interior space view with a specific geographic location of a user profile in the user profiles. The system may further include a seventh instruction set to create a wiki profile and content and to add the wiki profile and content to a particular user profile in the user profiles.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an integrated virtual view environment communicating with users through a network, according to one embodiment.

FIG. 2 is an exploded view of the social network module of FIG. 1, according to one embodiment.

FIG. 3 is an exploded view of the additional modules of FIG. 1, according to one embodiment.

FIG. 4 is a user profile view of the integrated virtual view environment of FIG. 1, according to one embodiment.

FIG. 5 is a multi-view of a user profile, according to one embodiment.

FIG. 6 is a virtual interior space view of a particular structure associated with the user profile, according to one embodiment.

FIG. 7 is a table view showing details of different structures associated with specific geographic locations of the user profiles, according to one embodiment.

FIG. 8 is a diagrammatic system view of a data processing system in which any of the embodiments disclosed herein may be performed, according to one embodiment.

FIG. 9 is a virtual interior space view of a multi-structure complex in the integrated virtual view environment, according to one embodiment.

FIG. 10 is a graphical representation of a geographic area accessible by the public, according to one embodiment.

FIG. 11 is a schematic representation of a capture device, according to one embodiment.

FIG. 12A is a process flow of generating a virtual interior space view of a structure associated with a geographic location, according to one embodiment.

FIG. 12B is a continuation of the process flow of FIG. 12A, showing additional processes, according to one embodiment.

Other features of the present embodiments will be apparent from the accompanying drawings and from the detailed description that follows.

### DETAILED DESCRIPTION

A method, apparatus and system of interior spaces in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

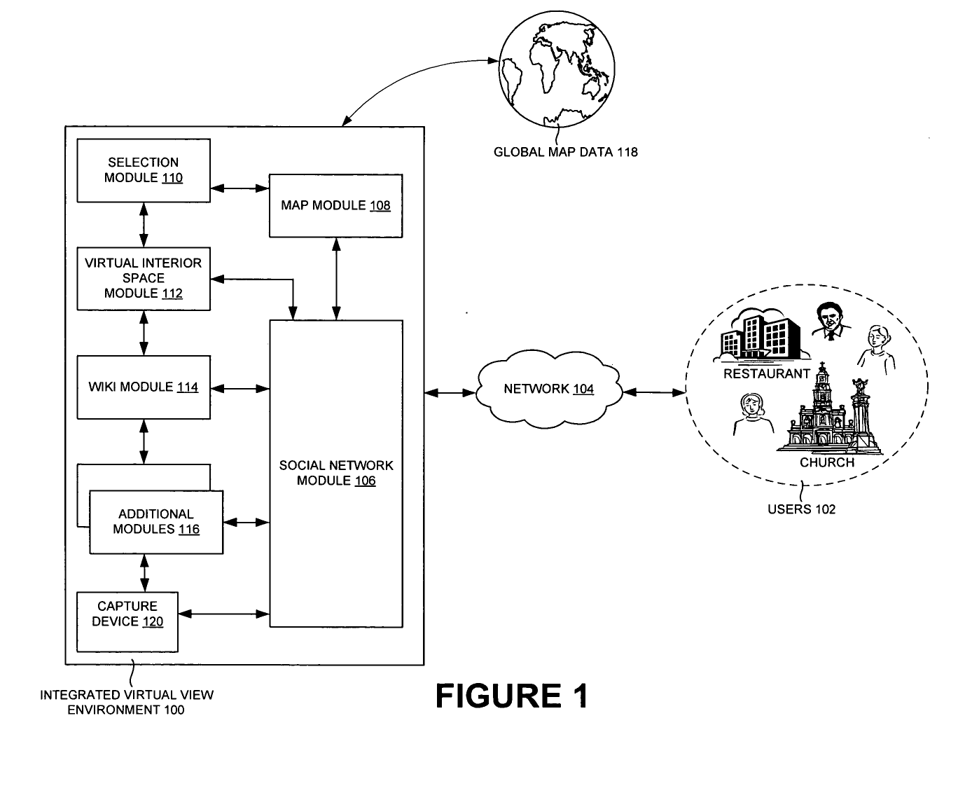

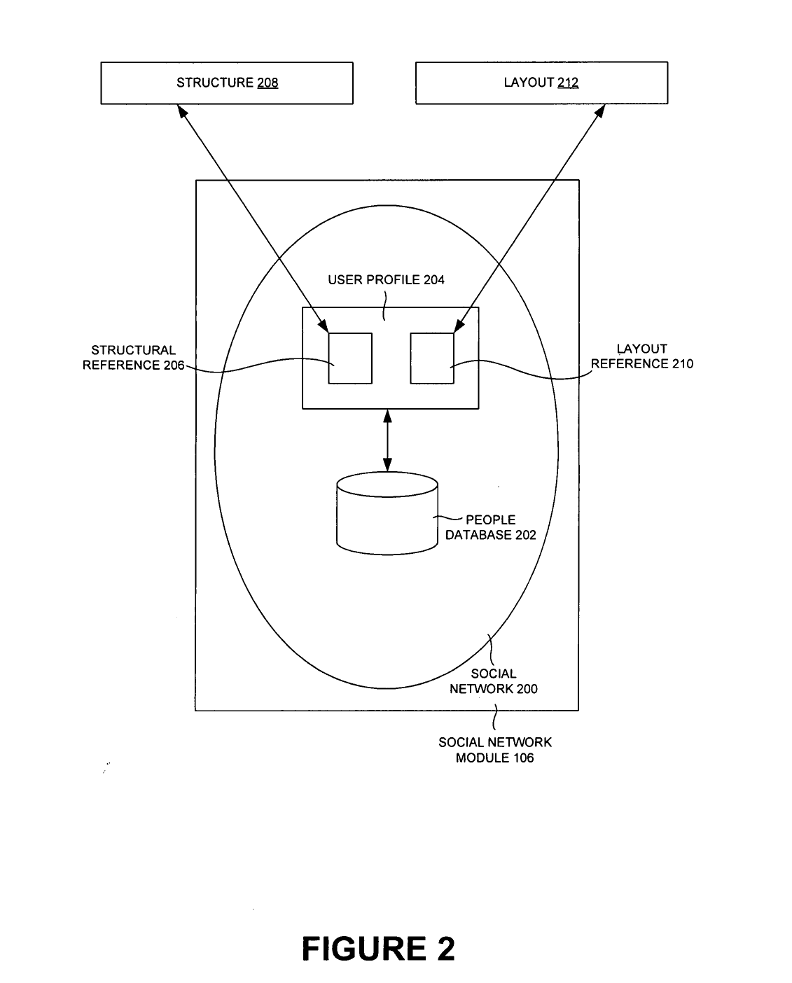

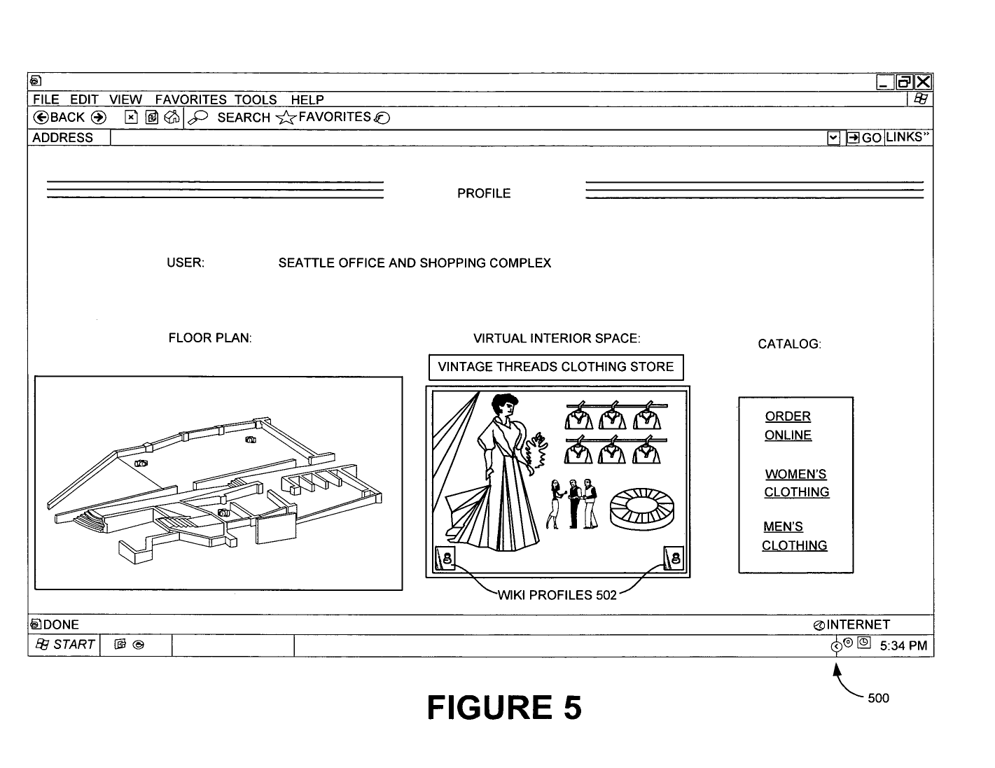

In one embodiment, a method includes providing a plurality of user profiles, each user profile (e.g., the user profile 204 of FIG. 2) in the plurality of user profiles 204 including an associated specific geographic location, selecting a user profile 204 (e.g., using the selection module 110 of FIG. 1) in the plurality of user profiles 204, generating a first virtual interior space view (e.g., using the virtual interior space module 112 of FIG. 1) of a first structure associated with a first specific geographic location of the selected user profile 204 in the plurality of user profiles 204, and generating, with the first virtual interior space view, at least one wiki profile (e.g., the wiki profiles 502 illustrated in FIG. 5, using the wiki module 114 of FIG. 1) associated with the first virtual interior space view.

In another embodiment, a system includes an integrated virtual view environment (e.g., the integrated virtual view environment 100 of FIG. 1), a social network module (e.g., the social network module 106 of FIG. 1) of the integrated virtual view environment 100 to include user profiles 204, each user profile 204 to include at least one virtual interior space view of a structure (e.g., the structure may further include a geographic area accessible to at least one public person) and a specific geographic location of the structure, a map module (e.g., the map module 108 of FIG. 1) to include map data of specific geographic locations, the map data to serve as a basis to correlate the specific geographic locations of the map data with virtual interior space views of structures associated with the specific geographic locations, a selection module (e.g., the selection module 110 of FIG. 1) to select a user profile 204, a virtual interior space module (e.g., the virtual interior space module 112 of FIG. 1) to generate the virtual interior space view of the structure of the user profile 204, and a wiki module (e.g., the wiki module 114 of FIG. 1) to generate, with the virtual interior space view of the structure of the user profile 204, at least one wiki profile 502 associated with the virtual interior space view of the user profile 204.

In yet another embodiment, an integrated virtual view environment 100 includes a first instruction set to enable a social network (e.g., the social network 200 of FIG. 2) including a user database, the user database including associated user profiles 204, the social network to reside above global map data (e.g., the global map data 118 of FIG. 1), in which the social network 200 is associated with specific geographic locations identifiable in the global map data, a second instruction set integrated with the first instruction set to select a user profile 204, the user profile 204 including a layout reference to a layout associated with the specific geographic location identifiable in the global map data, and a third instruction set integrated with the first instruction set and the second instruction set to generate a virtual private property space view (e.g., a zoo map, a walking path in an amusement park, a location visited often by a public audience on a private property, a stadium, a meeting place, a shopping center, a building, and/or an interior space) of a private property associated with the layout reference of the selected user profile 204.

FIG. 1 is a system view of an integrated virtual view environment 100 communicating with users 102 through a network 104, according to one embodiment. Particularly, FIG. 1 illustrates the integrated virtual view environment 100, the users 102, the network 104, a social network module 106, a map module 108, a selection module 110, a virtual interior space module 112, a wiki module 114, additional modules 116, global map data 118 and a capture device 120, according to one embodiment.

The integrated virtual view environment 100 may be a virtual environment which enables visualization of three dimensional virtual interior space view(s) of a structure associated with a user profile. The users 102 may be residents, businesses, communities, patrons and/or any other person associated with a geographic location of the structure in the integrated virtual view environment 100. The network 104 may enable communication between the integrated virtual view environment 100 and the users 102. The social network module 106 may contain user profiles 204 having a virtual interior space view of structures and/or specific geographic locations of the structures.

The map module 108 may contain map data of specific geographic locations to visualize the virtual interior space view of the structures associated with the specific geographic locations. The selection module 110 may enable selection of a user profile in any number of the user profiles. The virtual interior space module 112 may generate the virtual interior space view of the structure associated with the specific geographic location of the user profile.

The wiki module 114 may generate at least one wiki profile 502 associated with the virtual interior space view of the structure of the user profile 204. The additional modules 116 may generate additional processes to facilitate creation of the wiki profiles 502 and append the wiki profiles 502 to the virtual interior space view of the structure associated with the specific geographic location. The global map data 118 may contain location information that correlates the specific geographic locations of the map data with the virtual interior spaces of structures associated with the specific geographic locations. The capture device 120 may capture the virtual interior space view of the structures (e.g., the structures 208 illustrated in FIG. 2) associated with the specific geographic locations (e.g., may record, process and/or store audio, images and/or video, etc.).

In the example embodiment illustrated in FIG. 1, the integrated virtual view environment 100 communicates with the users 102 through the network 104. The integrated virtual view environment 100 communicates with the global map data 118. The integrated virtual view environment 100 includes the social network module 106, the map module 108, the selection module 110, the virtual interior space module 112, the wiki module 114, the additional modules 116 and the capture device 120 interacting with each other, as illustrated in the example embodiment of FIG. 1.

User profiles (e.g., the user profile 204 of FIG. 2) may be provided in the integrated virtual view environment 100 (e.g., each user profile 204 may include an associated specific geographic location). The user profile 204 may be selected (e.g., using the selection module 110 of FIG. 1) and/or a first virtual interior space view of a first structure (e.g., the structure 208 of FIG. 2) associated with a first specific geographic location of the selected user profile 204 may be generated (e.g., using the virtual interior space module 112 of FIG. 1). At least one wiki profile 502 associated with the first virtual interior space view may be generated (e.g., using the wiki module 114 of FIG. 1), with the first virtual interior space view. A second virtual interior space view of a second structure associated with a second specific geographic location may also be captured.

The map module 108 may include the map data (e.g., the global map data 118 of FIG. 1) of the specific geographic locations. For example, the map data may serve as a basis to correlate the specific geographic locations of map data with virtual interior space views of the structures (e.g., the structure 208 of FIG. 2) associated with the specific geographic locations. The selection module 110 may select the user profile 204 (e.g., in the integrated virtual view environment 100).

The virtual interior space module 112 may generate the virtual interior space view of the structure 208 of the user profile 204. The wiki module 114 may generate at least one wiki profile 502 associated with the virtual interior space view of the structure 208 of the user profile 204 along with the virtual interior space view. The capture device 120 may capture a virtual interior space view of a second structure 208 having a corresponding specific geographic location.

A first instruction set may enable a social network (e.g., the social network 200 of FIG. 2) including a user database (e.g., the people database 202 of FIG. 2), the user database including associated user profiles 204, the social network 200 to reside above the global map data, in which the social network 200 is associated with the specific geographic locations identifiable in the global map data.

A second instruction set integrated with the first instruction set may select a user profile 204. For example, the user profile 204 may include a layout reference to a layout associated with the specific geographic location identifiable in the global map data (e.g., the global map data 118 of FIG. 1). A third instruction set integrated with the first instruction set and the second instruction set may generate a virtual private property space view (e.g., a zoo map, a walking path in an amusement park, a location visited often by a public audience on a private property, a stadium, a meeting place, a shopping center, a building, and/or an interior space) of a private property associated with the layout reference of the selected user profile 204.

A fourth instruction set may generate the wiki profiles (e.g., the wiki profile 502 of FIG. 5, associated with a specific user profile 204 of the social network 200). A fifth instruction set may generate content (e.g., the content may be appended to the wiki profile 502). A sixth instruction set may capture (e.g., using the capture device 120 of FIG. 1) a virtual interior space view (e.g., the virtual interior space view of the second structure) and may associate the virtual interior space view with a specific geographic location of a user profile 204. A seventh instruction set may create a wiki profile 502 and content and/or may add the wiki profiles 502 and content to a particular user profile 204.

FIG. 2 is an exploded view of the social network module 106 of FIG. 1, according to one embodiment. Particularly, FIG. 2 illustrates a social network 200, a people database 202, a user profile 204, a structural reference 206, and a structure 208, according to one embodiment.

The social network 200 may be a social network (e.g., a community) formed by an association of the users 102 having user profiles 204 in the integrated virtual view environment (e.g., the integrated virtual view environment 100 of FIG. 1). The people database 202 may contain the user profiles 204 associated with the specific geographic locations in the social network 200 of the integrated virtual view environment 100. The user profile 204 may contain information associated with an address data of the structure 208 associated with the specific geographic location. The structural reference 206 may provide a reference of the particular structure 208 associated with the specific geographic location of the user profile 204. The structure 208 may represent a shopping center, a mall, a building, a multi store complex, etc. associated with the specific geographic location in the virtual view environment (e.g., the integrated virtual view environment 100 of FIG. 1).

In the example embodiment illustrated in FIG. 2, the social network module 106 includes the social network 200. The social network 200 includes the people database 202 which further includes the user profile 204. The user profile 204 includes the structure 208 having the structural reference 206, according to the example embodiment illustrated in FIG. 2.

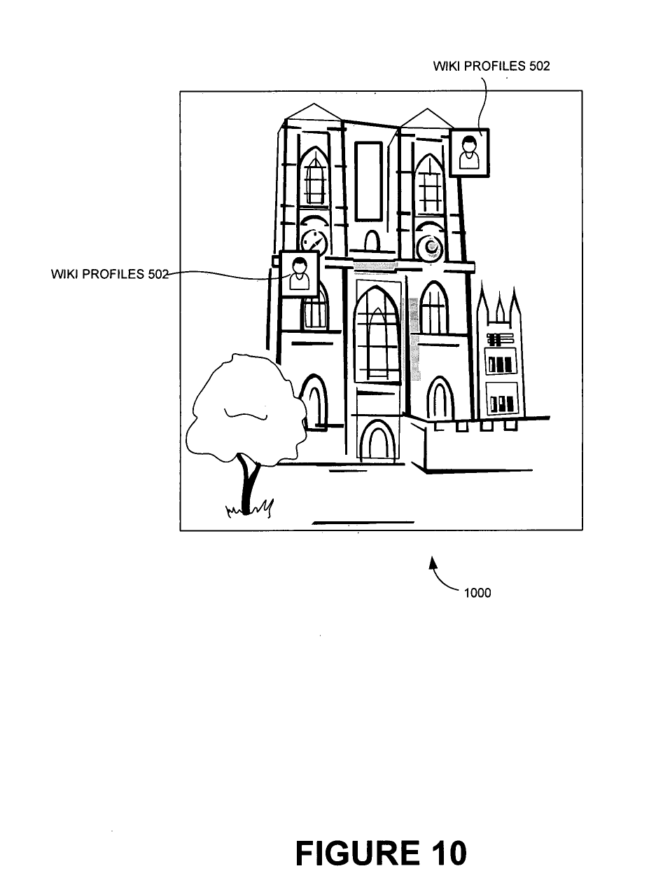

Each user profile (e.g., the user profile 204 of FIG. 2 provided in the integrated virtual view environment 100) may include an associated specific geographic location. The social network module (e.g., the social network module 106 of FIG. 1-2) of the integrated virtual view environment 100 may include user profiles 204 (e.g., each user profile 204 may include the at least one virtual interior space view of the structure 08 and/or the specific geographic location of the structure 208). The structure 208 may further include the geographic area (e.g., the geographic area accessible to public 1000 of FIG. 10) accessible to at least one public person.

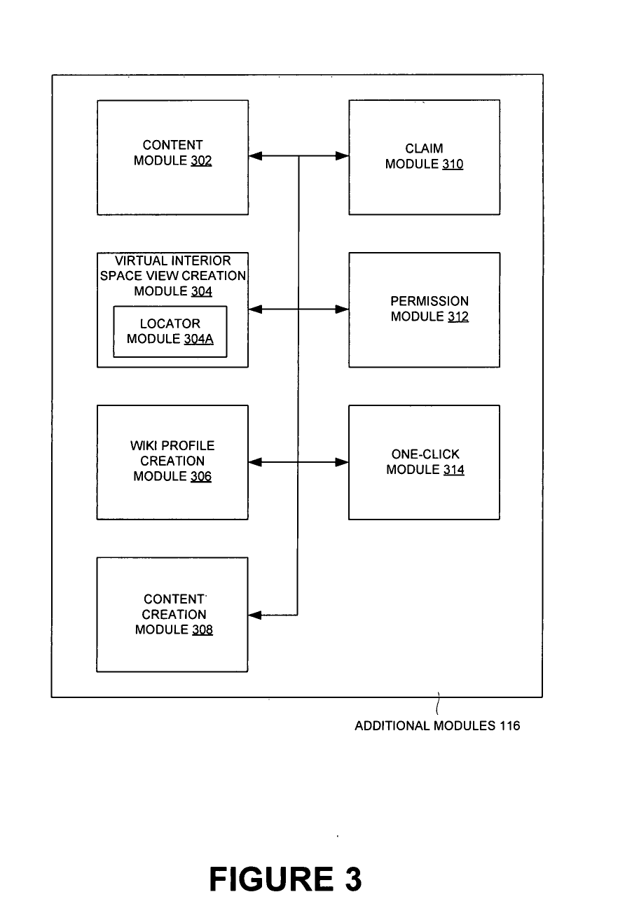

FIG. 3 is an exploded view of the additional modules 116 of FIG. 1, according to one embodiment. Particularly, FIG. 3 illustrates a content module 302, a virtual interior space view creation module 304, a locator module 304A, a wiki profile creation module 306, a content creation module 308, a claim module 310, a permission module 312 and a one-click module 314, according to one embodiment.

The content module 302 may generate content appended to the at least one wiki profile 502. The virtual interior space view creation module 304 may capture the virtual interior space view of the structure 208 (e.g., the second structure) and associate the virtual interior space view with a user profile 204.

The locator module 304A may determine the specific geographic location of the structure 208 and/or may associate the specific geographic location with the captured virtual interior space view. The wiki profile creation module 306 may enable creation of the wiki profile 502 and/or may append the wiki profile 502 to the virtual interior space view associated with the specific geographic location of the selected user profile 204. The content creation module 308 may create and append content (e.g., comments, reviews, feedback, notes, ratings, clips, etc.) to the wiki profile 502 associated with the virtual interior space view. The claim module 310 may enable claiming of user profiles 204 associated with the particular interior space view in the social network 200.

The permission module 312 may permit or prohibit modification of a claimed user profile 204 associated with the particular virtual interior space view of the structure 208. The one-click module 314 may enable selection of a service associated with the user profile 204 and/or may facilitate providing of the selected service based on the specific geographic location of the user profile 204.

In the example embodiment illustrated in FIG. 3, the additional modules 116 include the content module 302, the virtual interior space view creation module 304, the wiki profile creation module 306, the content creation module 308, the claim module 310, the permission module 312 and the one-click module 314 interacting with each other. In addition, the virtual interior space view creation module 304 includes the locator module 304A, according to the example embodiment illustrated in FIG. 3.

The second virtual interior space view may be associated with a user profile 204 associated with the second specific geographic location. The content module 302 may generate the content associated with the wiki profile 502 and/or the content may be appended to the associated wiki profile 502 (e.g., the content appended to the wiki profile 502 may be generated with the wiki profile 502).

The virtual interior space view creation module 304 may capture the virtual interior space view of the structure (e.g., the structure 208 of FIG. 2) and/or may associate the virtual interior space view with a particular user profile 204. The locator module 304A may determine a specific geographic location of the structure 208 associated with the virtual interior space view, and/or may associate the specific geographic location of the structure with a captured virtual interior space view.

The wiki profile creation module 306 may create a wiki profile 502 and/or append the wiki profile 502 to the virtual interior space view of an associated user profile 204. The content creation module 308 may create and/or append the content to the wiki profile 502 associated with the virtual interior space view. The claim module 310 may claim (e.g., may allow a user 102 to claim) a specific user profile 204. The permission module 312 may permit or prohibit modification of a claimed user profile 204.

The one-click module 314 may select the service associated with a user profile 204 and/or may provide the selected service based on the specific geographic location of the user profile 204. The capture device (e.g., the capture device 120 of FIG. 1) may further include a locator device (e.g., a GPS device) to determine the specific geographic location of the structure and/or may associate the corresponding specific geographic location of the structure with the captured virtual interior space view.

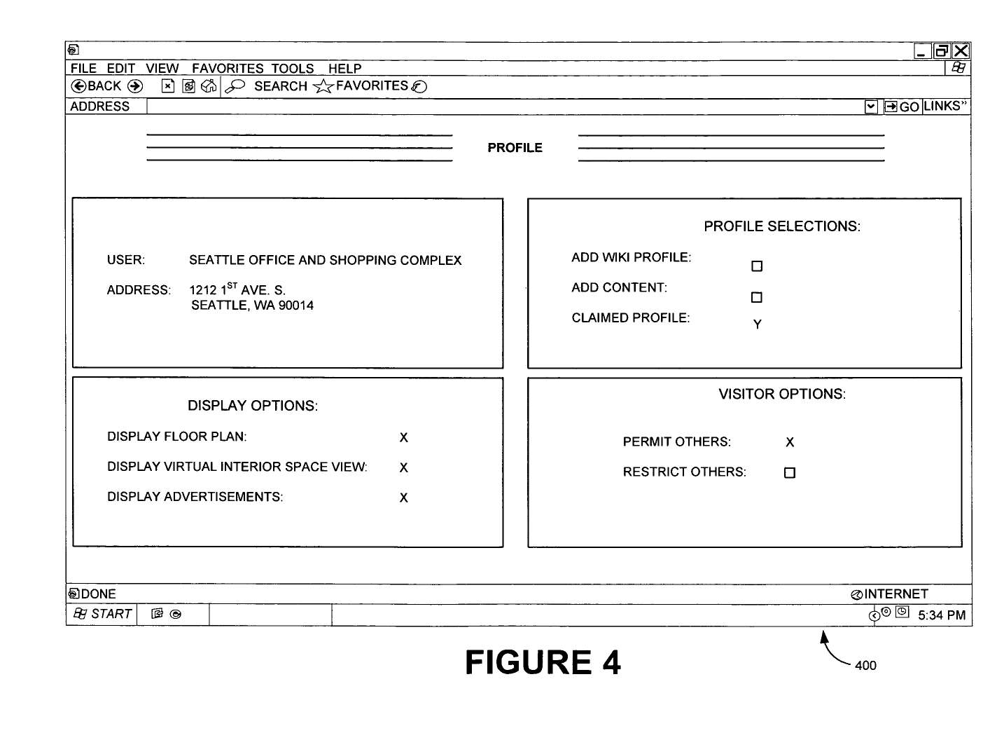

FIG. 4 is a user profile view 400 of the integrated virtual view environment 100 of FIG. 1, according to one embodiment. The user profile view 400 may display information associated with a profile of the user 102 of the social network 200. The user profile view 400 may display an address (e.g., a street, a city, a zip code) associated with the user profile (e.g., the user profile 204 of FIG. 2). The user profile view 400 may enable the user 102 to add wiki profiles 502 associated with a virtual interior space view of structures 208 of other user profiles 204. The user profile view 400 may also enable the user 102 to update content associated with the wiki profile 502 of the virtual interior space view of the structure 208.

The user profile view 400 may permit other users 102 to view and/or modify the wiki profiles 502 associated with the interior space view of the structure 208. The user profile view 400 may offer a display floor plan option (e.g., to show a physical layout of objects in a particular physical location and/or structure 208). Also, the user profile view 400 may offer a display virtual interior space view option to graphically visualize the interior space of the structure 208 associated with a specific geographic location. In addition, the user profile view 400 may also offer a display advertisements option (e.g., that generates promotional content and/or advertisements associated with a selected option).

FIG. 5 is a multi-view 500 of a user profile (e.g., the user profile 204 of FIG. 2), illustrating wiki profiles 502, according to one embodiment. In one example embodiment, the multi-view 500 may visualize (e.g., in a map) a floor plan that represents a scale drawing of a horizontal section through a building at a given level, viewed as seen from the top. The multi-view 500 may display the virtual interior space view of the particular structure 208 (e.g., the building) associated with a specific geographic location.

The wiki profiles 502 may be profiles associated with the particular structure 208 in the geographic location that is displayed (e.g., in interior space view) in the example embodiment illustrated in FIG. 5. The multi-view 500 may also display a catalog (e.g., order online, men's clothing, etc.) of the products associated with a customizable business displayed to urge a user 102 to buy the products of the customizable business, in the example embodiment illustrated in FIG. 5.

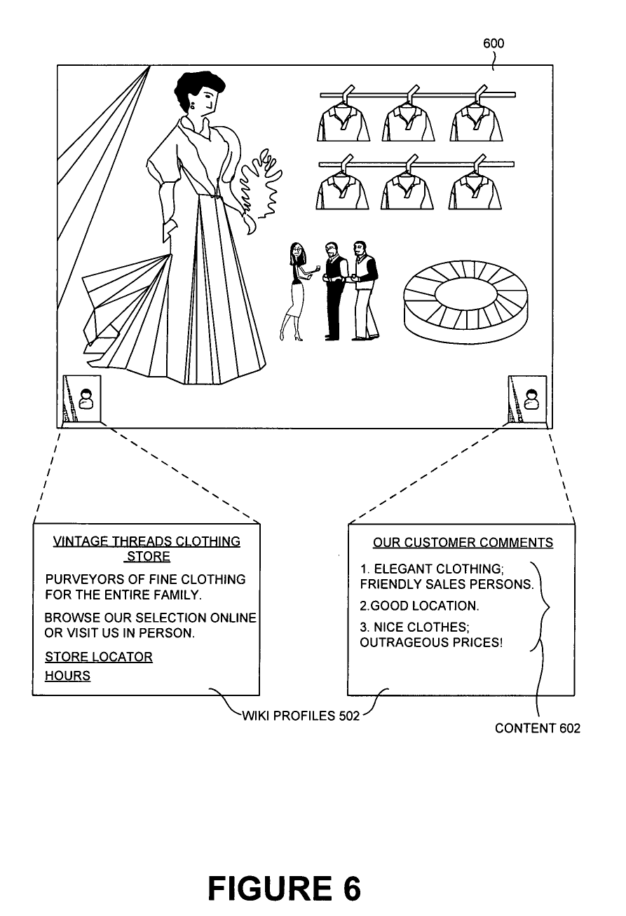

FIG. 6 is a virtual interior space view 600 of a particular structure associated with a specific geographic location, according to one embodiment. Particularly, FIG. 6 illustrates the wiki profiles 502, the virtual interior space view 600 and content 602, according to one embodiment.

The virtual interior space view 600 may display the virtual interior space of a particular structure 208 associated with the geographic location of a selected user profile 204. The virtual interior space view 600 may also display the wiki profiles 502 associated with the interior space (e.g., of the structure 208). The wiki profiles 502 may display the content 602 (e.g., and/or different offers associated with the particular structure 208) and/or may simultaneously display comments posted by the customers on the particular business associated with the structure 208 by selecting the wiki profiles 502, according to the example embodiment illustrated in FIG. 6.

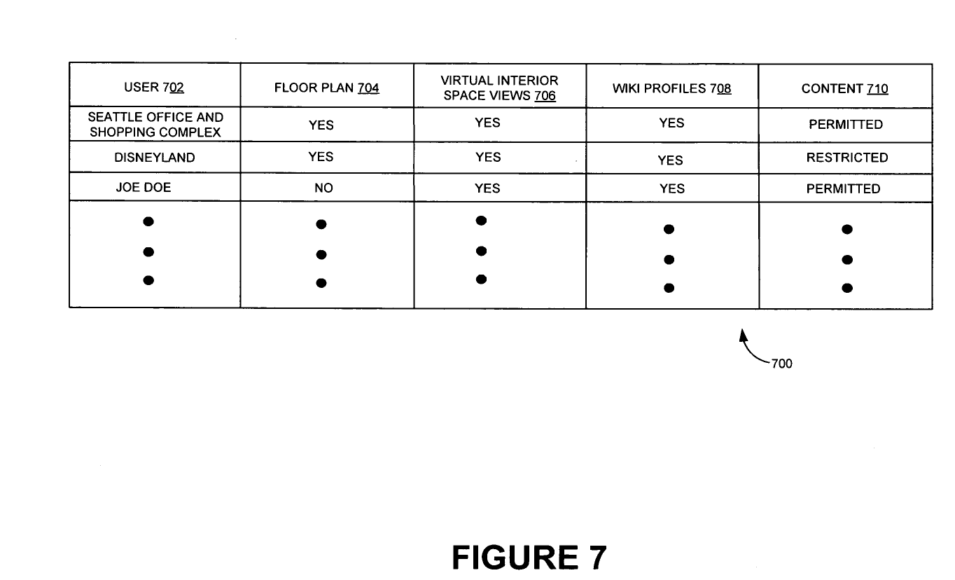

FIG. 7 is a table view 700 showing details of different structures (e.g., the structure 208 illustrated in FIG. 2) associated with the specific geographic locations of the user profiles (e.g., the user profiles 204 illustrated in FIG. 2), according to one embodiment. Particularly, FIG. 7 illustrates a user field 702, a floor plan field 704, a virtual interior space views field 706, a wiki profiles field 708 and a content field 710, according to one embodiment.

The user field 702 may display descriptive names of the structures 208 associated with the geographic location in the virtual view environment 100. The floor plan field 704 may represent whether the floor plan for the structure 208 associated with the specific geographic location is available or not. The virtual interior space views field 706 may also display availability data of the structure 208 associated with the geographic location.

The wiki profiles field 708 may display wiki profiles 502 of the virtual interior spaces associated with the particular geographic location. The content field 710 may display visitor options, and/or whether other users (e.g., the users 102 of FIG. 1) are permitted to post comments and/or to modify content associated with the structure 208 associated with the specific geographic location.

In the example embodiment illustrated in FIG. 7, the user field 702 displays “Seattle Office and Shopping Complex” in the first row, “Disneyland” in the second row and “Joe Doe” in the third row of the user field column 702. The floor plan field 704 displays “yes” in the first row and the second row and “no” in the third row of the floor plan field column 704. The virtual interior space views 706 displays “yes” in the first row, the second row and the third row of the virtual interior space views field column 706. The wiki profiles field 708 displays “yes” in the first row, the second row and the third row of the wiki profiles field column 708. The content field 710 displays “permitted” in the first row and the third row and “restricted” in the second row of the content field column 710.

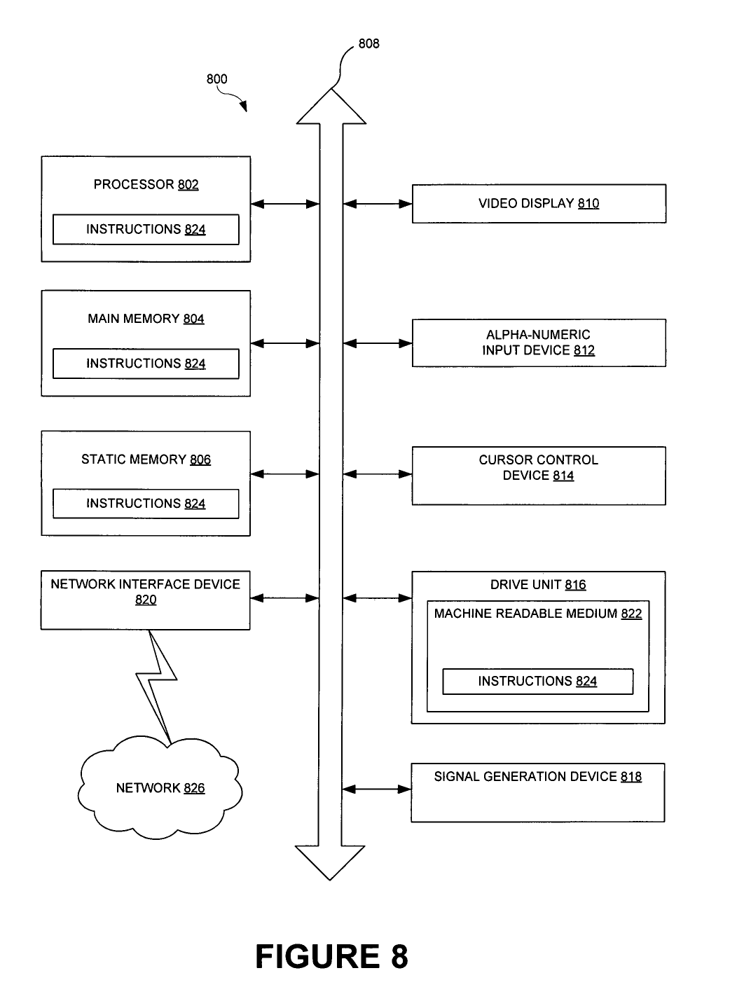

FIG. 8 is a diagrammatic system view 800 of a data processing system in which any of the embodiments disclosed herein may be performed, according to one embodiment. Particularly, the system view 800 of FIG. 8 illustrates a processor 802, a main memory 804, a static memory 806, a bus 808, a video display 810, an alpha-numeric input device 812, a cursor control device 814, a drive unit 816, a signal generation device 818, a machine readable medium 822, instructions 824, and a network 826, according to one embodiment.

The diagrammatic system view 800 may indicate a personal computer and/or a data processing system in which one or more operations disclosed herein are performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., a special device to aid the physically handicapped). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The machine readable medium 822 may provide instructions on which any of the methods disclosed herein may be performed. The instructions 824 may provide source code and/or data code to the processor 802 to enable any one/or more operations disclosed herein.

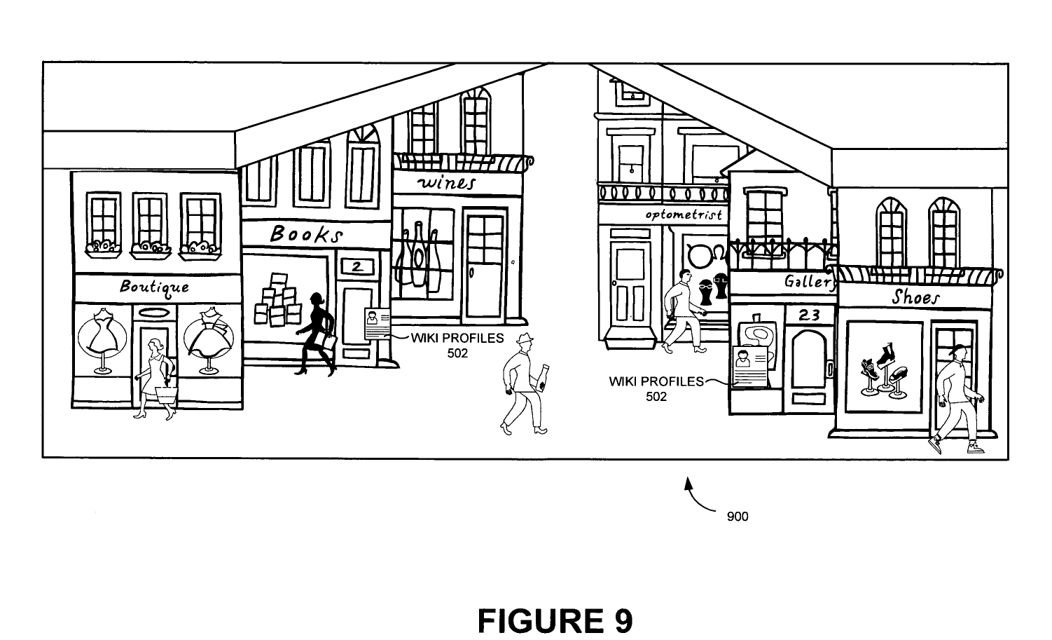

FIG. 9 is a virtual interior space view 900 of a multi-structure complex, according to one embodiment. The virtual interior space view 900 may visualize the real or imaginary environment inside a specific multi-structure (e.g., multi-store) complex, in a three dimensional display. The virtual interior space view 900 may also locate businesses (e.g., boutiques, bookstores, galleries, etc.) inside the complex in the three dimensional display, as illustrated in the example embodiment of FIG. 9. The wiki profiles 502 associated with the different structures (e.g., the structures 208 of FIG. 2) inside the complex may be displayed along with the structures 208 in the virtual view environment 100 as illustrated in the example embodiment of FIG. 9.

FIG. 10 is a graphical representation of a geographic area 1000 accessible by the public, according to one embodiment. The graphical view of the geographic area accessible by the public 1000 may display a physical structure 208 associated with a specific geographic location in a social network 200. The wiki profiles 502 may display content (e.g., posted by users 102) associated with virtual interior space views of the structure 208, in the example embodiment illustrated in FIG. 10.

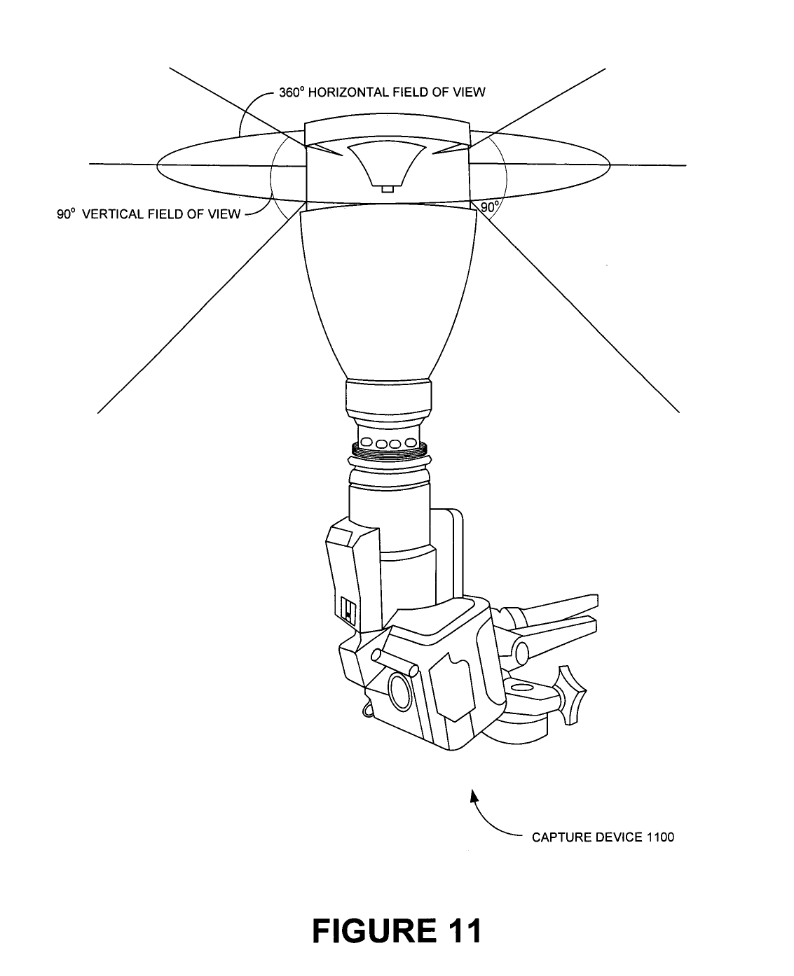

FIG. 11 is a schematic representation of a capture device 1100, according to one embodiment. The capture device 1100 (e.g., an example embodiment of the capture device 120 of FIG. 1) may be used to capture a virtual interior space view of a structure 208 associated with a specific geographic location. The cylindrical part at the top of capture device 1100 may cover a horizontal field of view of up to 360 degrees and a vertical field of view of up to 90 degrees within the physical structure 208, as illustrated in the example embodiment of FIG. 11.

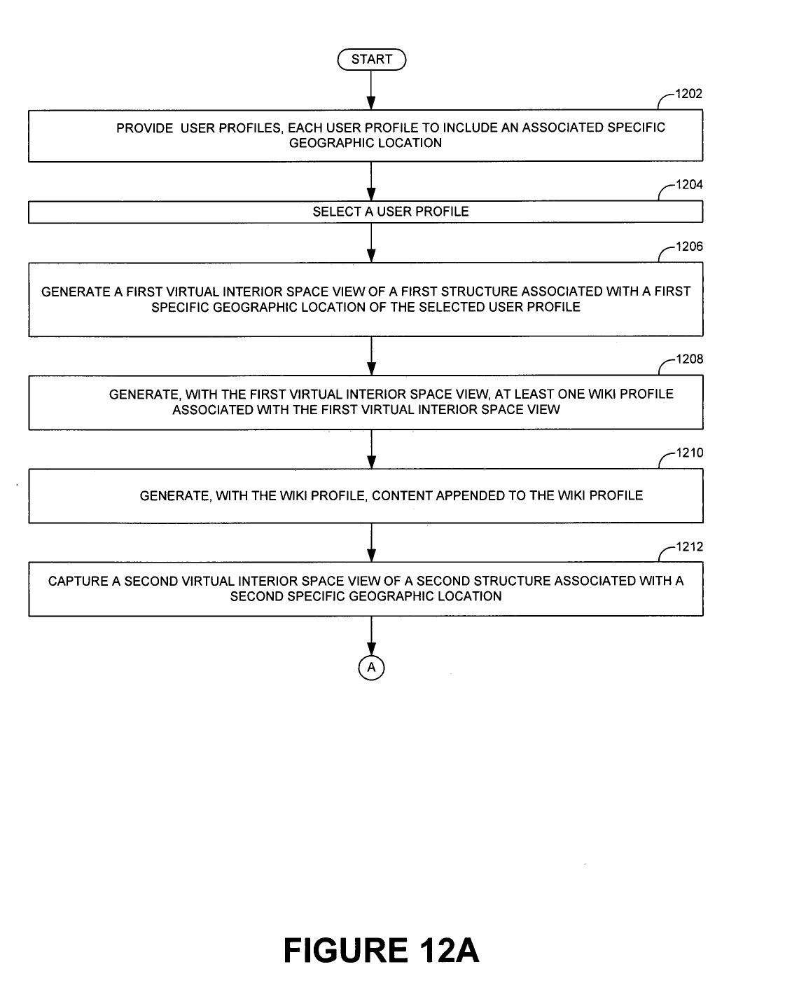

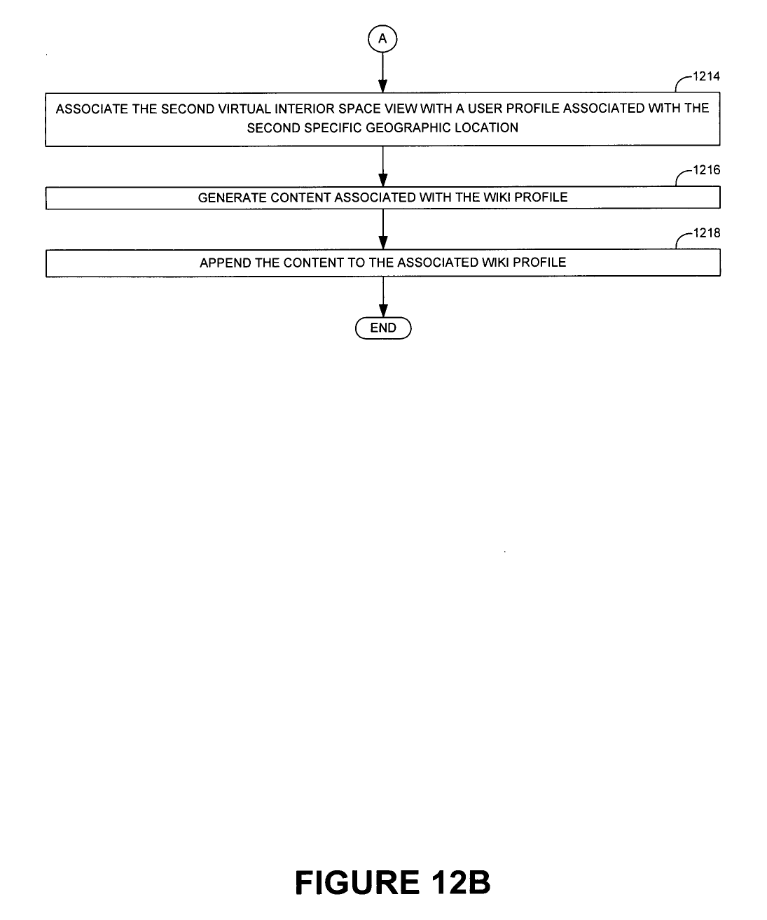

FIG. 12A is a process flow of generating a virtual interior space view of a structure (e.g., the structure 208 of FIG. 2), according to one embodiment. In operation 1202, user profiles (e.g., the user profiles 204 of FIG. 2) may be provided, each user profile 204 to include an associated specific geographic location. In operation 1204, a user profile 204 may be selected (e.g., using the social network module 106 of FIG. 1). In operation 1206, a first virtual interior space view of a first structure 208 associated with a first specific geographic location of the selected user profile 204 may be generated (e.g., using the virtual interior space view creation module 304 of FIG. 3). In operation 1208, at least one wiki profile (e.g., the wiki profiles 502 of FIG. 5) associated with the first virtual interior space view may be generated with the first virtual interior space view (e.g., using the wiki profile creation module 306 of FIG. 3). In operation 1210, content appended to the wiki profile 502 may be generated with the wiki profile 502 (e.g., using the content creation module 308 of FIG. 3). In operation 1212, a second virtual interior space view of a second structure 208 associated with a second specific geographic location may be captured (e.g., using the capture device 1100 illustrated in FIG. 11).

FIG. 12B is a continuation of the process flow of FIG. 12A, showing additional processes, according to one embodiment. In operation 1214, the second virtual interior space view may be associated with a user profile 204 associated with the second specific geographic location (e.g., using the virtual interior space module 112 of FIG. 1). In operation 1216, content associated with the wiki profile 204 may be generated. In operation 1218, the content may be appended to the associated wiki profile 502 (e.g., using the content module 302 of FIG. 3).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry). For example, the social network module 106, the map module 108, the selection module 110, the virtual interior space module 112, the wiki module 114, the additional modules 116, the content module 302, the virtual interior space view creation module 304, the locator module 304A, the wiki profile creation module 306, the content creation module 308, the claim module 310, the permission module 312, and the one click module 314 of FIGS. 1-14 may be enabled using a social network circuit, a map circuit, a selection circuit, a virtual interior space circuit, a wiki circuit, additional circuits, a content circuit, a virtual interior space view creation circuit, a locator circuit, a wiki profile creation circuit, a content creation circuit, a claim circuit, a permission circuit, a one click circuit and other circuits using one or more of the technologies described herein. In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
providing a plurality of user profiles, each user profile in the plurality of user profiles including an associated specific geographic location;
selecting a user profile in the plurality of user profiles;
generating a first virtual interior space view of a first structure associated with a first specific geographic location of the selected user profile in the plurality of user profiles; and
generating, with the first virtual interior space view, at least one wiki profile associated with the first virtual interior space view.

2. The method of claim 1, further comprising:
generating, with the at least one wiki profile, content appended to the at least one wiki profile.

3. The method of claim 2, further comprising:
capturing a second virtual interior space view of a second structure associated with a second specific geographic location; and
associating the second virtual interior space view with a user profile associated with the second specific geographic location in the plurality of user profiles.

4. The method of claim 1, further comprising:
generating content associated with the at least one wiki profile; and
appending the content to the associated at least one wiki profile.

5. The method of claim 1 in a form of a machine-readable medium embodying a set of instructions that, when executed by a machine, causes the machine to perform the method of claim 1.

6. A system comprising:
an integrated virtual view environment;
a social network module of the integrated virtual view environment to include user profiles, each user profile to include at least one virtual interior space view of a structure and a specific geographic location of the structure;
a map module to include map data of specific geographic locations, the map data to serve as a basis to correlate the specific geographic locations of the map data with virtual interior space views of structures associated with the specific geographic locations;
a selection module to select a user profile in the user profiles;
a virtual interior space module to generate the virtual interior space view of the structure of the user profile; and
a wiki module to generate, with the virtual interior space view of the structure of the user profile, at least one wiki profile associated with the virtual interior space view of the user profile.

7. The system of claim 6, further comprising:
a content module to generate, with the at least one wiki profile, content appended to the at least one wiki profile.

8. The system of claim 6, further comprising:
a virtual interior space view creation module to capture the virtual interior space view of the structure and to associate the virtual interior space view with a particular user profile in the user profiles.

9. The system of claim 8, further comprising:
a locator module to determine a specific geographic location of the structure associated with the virtual interior space view and to associate the specific geographic location of the structure with the captured virtual interior space view.

10. The system of claim 6, further comprising:
a wiki profile creation module to create a wiki profile and append the wiki profile to the virtual interior space view of an associated user profile in the user profiles.

11. The system of claim 6, further comprising:
a content creation module to create and append content to the at least one wiki profile associated with the virtual interior space view.

12. The system of claim 6, further comprising:
a claim module to claim a specific user profile in the user profiles.

13. The system of claim 12, further comprising:
a permission module to permit or prohibit modification of a claimed user profile in the user profiles.

14. The system of claim 6, further comprising:
a one-click module to select a service associated with a user profile in the user profiles and to provide the selected service based on the specific geographic location of the user profile.

15. The system of claim 6, further comprising:
a capture device to capture a virtual interior space view of a second structure having a corresponding specific geographic location.

16. The system of claim 15, wherein the capture device further comprises a locator device to determine the specific geographic location of the structure and to associate the corresponding specific geographic location of the structure with the captured virtual interior space view.

17. The system of claim 6, wherein the structure further comprises a geographic area accessible to at least one public person.

18. An integrated virtual view environment, comprising:
a first instruction set to enable a social network including a user database, the user database including associated user profiles, the social network to reside above global map data, in which the social network is associated with specific geographic locations identifiable in the global map data;
a second instruction set integrated with the first instruction set to select a user profile in the user profiles, the user profile including a layout reference to a layout associated with a specific geographic location identifiable in the global map data; and
a third instruction set integrated with the first instruction set and the second instruction set to generate a virtual private property space view of a private property associated with the layout reference of the selected user profile.

19. The system of claim 18, further comprising:
a fourth instruction set to generate wiki profiles, wherein at least one wiki profile is associated with a specific user profile in the user profiles of the social network, and wherein the virtual private property space view is at least one of a zoo map, a walking path in an amusement park, a location visited often by a public audience on private property, a stadium, a meeting place, a shopping center, a building, and an interior space.

20. The system of claim 19, further comprising:
a fifth instruction set to generate content, wherein the content is appended to the at least one wiki profile.

21. The system of claim 18, further comprising:
a sixth instruction set to capture a virtual interior space view and to associate the visual interior space view with a specific geographic location of a user profile in the user profiles.

22. The system of claim 18, further comprising:
a seventh instruction set to create a wiki profile and content and to add the wiki profile and content to a particular user profile in the user profiles.
